(19) United States
(12) Patent Application Publication
(10) Pub. No.: US 2014/0139224 A1
(43) Pub. Date: May 22, 2014

(54) STRAY WIRE LOCATION SENSOR

(71) Applicant: Stolar Research Corporation, Rio Rancho, NM (US)

(72) Inventors: Gerald L. Stolarczyk, Placitas, NM (US); Tito L. Sanchez, Rio Rancho, NM (US); Chance Dain Valentine, Raton, NM (US); John A. Myers, Raton, NM (US); Beaux L. Beard, Rio Rancho, NM (US); Ernest M. Salazar, Rio Rancho, NM (US); Richard Brewster Main, Newark, CA (US)

(73) Assignee: Stolar Research Corporation, Rio Ranch, NM (US)

(21) Appl. No.: 14/155,566

(22) Filed: Jan. 15, 2014

Related U.S. Application Data
(63) Continuation-in-part of application No. 13/862,379, filed on Apr. 13, 2013.
Application No. 13/862,379 is a continuation-in-part of application No. 13/301,762, filed on Nov. 21, 2011.
Application No. 13/301,762 is a continuation-in-part of application No. 14/150,736, filed on Jan. 8, 2014.

(51) Int. Cl. G01V 3/10

(52) U.S. Cl. CPC G01V 3/10
USPC 324/329

(57) ABSTRACT

A stray-wire sensor includes a vertical magnetic gradiometer (VMG) carried over the surface by ground vehicles or by low-flying aircraft. The VMG has a spot of sensitivity on the ground which stays nadir to the VMG itself. A Faraday shield surrounding the VMG screens out the near field electric dipole signals, and a ferrite rod core and winding inside act as an antenna sensitive to the near-field magnetic dipole signals which radiate from horizontal lying stray wires on the ground surface in the dirt of hidden by ground cover. The VMG depends on it being moved around over the ground so that magnetic signal gradients and reversals can be measured point-by-point. The nadir points which fall over a point along a long horizontal wire will express characteristic signatures in the signal gradients and phase reversals measureable in the antenna.

### RELATED APPLICATIONS

This application is a continuation-in-part of U.S. patent application Ser. No. 14/150,736 filed Jan. 8, 2014, and titled LARGE AREA GROUND MONITORING, and which in turn claims benefit of U.S. Provisional Patent Application 61/750,318 filed Jan. 8, 2013, and titled PREDISTORTED DOUBLE SIDEBAND GROUND PENETRATING GRADIOMETRIC RADAR WITH SUPPRESSION OF CLUTTERING REFLECTIONS, by Larry G. Stolarczyk; and it also claims benefit and is a continuation-in-part of U.S. patent application Ser. No. 13/862,379, filed Apr. 13, 2013, and titled, ELECTROMAGNETIC DETECTION AND IMAGING TRANSCEIVER (EDIT) AND ROADWAY TRAFFIC DETECTION SYSTEM, by Larry G. Stolarczyk; and also a continuation-in-part of U.S. patent application Ser. No. 13/301,762, filed Nov. 21, 2011, and titled, UNSYNCHRONIZED RADIO IMAGING, by Igor Bausov, Gerald Stolarczyk, and Larry G. Stolarczyk.

### BACKGROUND

1. Field of the Invention

The present invention relates to finding stray, stray wires on the surface of the ground or just below, and more particularly to employing vertical magnetic dipole sensors to pinpoint and log the relative locations and placements of small gauge but long wires.

2. Description of the Problems to be Solved

Finding stray, broken, or long segments of wire laying in the dirt or hidden in ground cover can be important for any number of security, defensive, economic, and operational reasons. Visual spotting is unreliable and fatiguing. Electromagnetic methods of doing this do not have to depend on sight. Some electromagnetic methods can be stood off the ground by a modest distance and still work quite well.

Magnetic fields can both be induced into and re-radiate away from wires and pipes on the ground surface of an area. Such re-radiated magnetic fields can provide telltales of the locations and orientations of metallic objects, especially long linear wires with stray ends.

Signal gradients are very pronounced and change rapidly as the detection equipment is moved in the vicinity of long wires that can't help but re-radiate secondary emissions. In contrast, far-field primary emissions from distant sources are characterized by near-zero difference signal gradients in the same area. Near-fields are dominated by dipole-type electric or magnetic fields. So one has only to distinguish between the primary and secondary signal types to find the nearby radiators.

There are at least two kinds of gradiometer instruments that can be used to measure magnetic fields. An axial gradiometer uses two magnetometers placed in series, e.g., one above the other. It measures differences in the magnetic flux at a point in space. A planar gradiometer situates two magnetometers next to one another. It measures the difference in flux between the two magnetometers. The axial and planar types will respond differently to spatial signals. Vector magnetometers can measure the magnetic field component directions relative to the device's spatial orientation.

Gradiometer instrumentation can sometimes be challenging to accommodate. Full-size ground, air, and water vehicles all have their limits. The size, weight, and power (SWAP) requirements of new kinds of onboard sensors and devices can sometimes be too much for first generation systems. This is especially true of small remote-controlled vehicles and drones that are not fully integrated. In contrast, stand-alone sensors developed as individual mix-and-match add-ons waste too much in resources, and the combinations are difficult to house in tight accommodations.

Stolar Research Corporation (Rio Rancho, N. Mex.) has developed a line of vertical magnetic gradiometers (VMG) that can be used singularly, in pairs, and in arrays to sweep over roadways and open fields. Their VMG's are carried by personnel on foot, vehicles, airplanes, kites, robots, and even drones. These products all descended from their earlier work with EM gradiometers on locating coal deposits and mines.

It now seems that further progress in the remote sensing sciences will depend on combining sensors such that they can be multi-purpose, cohabitate, and share system resources amongst them.

### SUMMARY OF THE INVENTION

Briefly, a stray-wire sensor embodiment of the present invention includes a vertical magnetic gradiometer (VMG) carried over the surface by ground vehicles or by low-flying aircraft. The VMG has a spot of sensitivity on the ground which stays nadir to the VMG itself. A Faraday shield surrounding the VMG screens out the near field electric dipole signals, and a ferrite rod core and winding inside act as an antenna sensitive to the near-field magnetic dipole signals which radiate from horizontal lying stray wires on the ground surface in the dirt of hidden by ground cover. The VMG depends on it being moved around over the ground so that magnetic signal gradients and reversals can be measured point-by-point. The nadir points which fall over a point along a long horizontal wire will express characteristic signatures in the signal gradients and phase reversals measureable in the antenna.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is a schematic and functional block diagram of a stray-wire finding device of the present invention;

FIG. 2 is a perspective view diagram of a roadway vehicle application in which vertical magnetic dipole gradiometers are carried in two single-file arrays, one outrigger array on each side of a vehicle;

FIG. 3 is a schematic and functional block diagram of a VMG-type sensor cube and receiver embodiment of the present invention;

FIGS. 4A, 4B, and 4C are a side view, cross sectional view, and top view of a vector magnetometer embodiment of the present invention;

FIG. 5 is a exploded assembly view in perspective of a triaxial sensor cube embodiment of the present invention;

FIG. 6 is a series of waveforms showing how algorithms can be employed in signal processing to overcome strong interference and produce more reliable detection results;

FIG. 7 is a waveform that illustrate how the vertical magnetic flux in a VMG will respond over time or relative distance to a re-radiating wire;

FIG. 8 is a side view of a truck and a cutaway of a roadbed the truck is traveling over and is intended to show the placement of the transmitting antennas and the signals they radiate;

FIG. 9 is an exploded assembly view diagram in perspective of a ruggedized antenna suitable for use in FIG. 8; and

FIG. 10 is an exploded assembly view diagram in perspective of a spring mount suitable for the ruggedized antennas in FIGS. 8 and 9.

### DETAILED DESCRIPTION OF THE PREFERRED EMBODIMENT

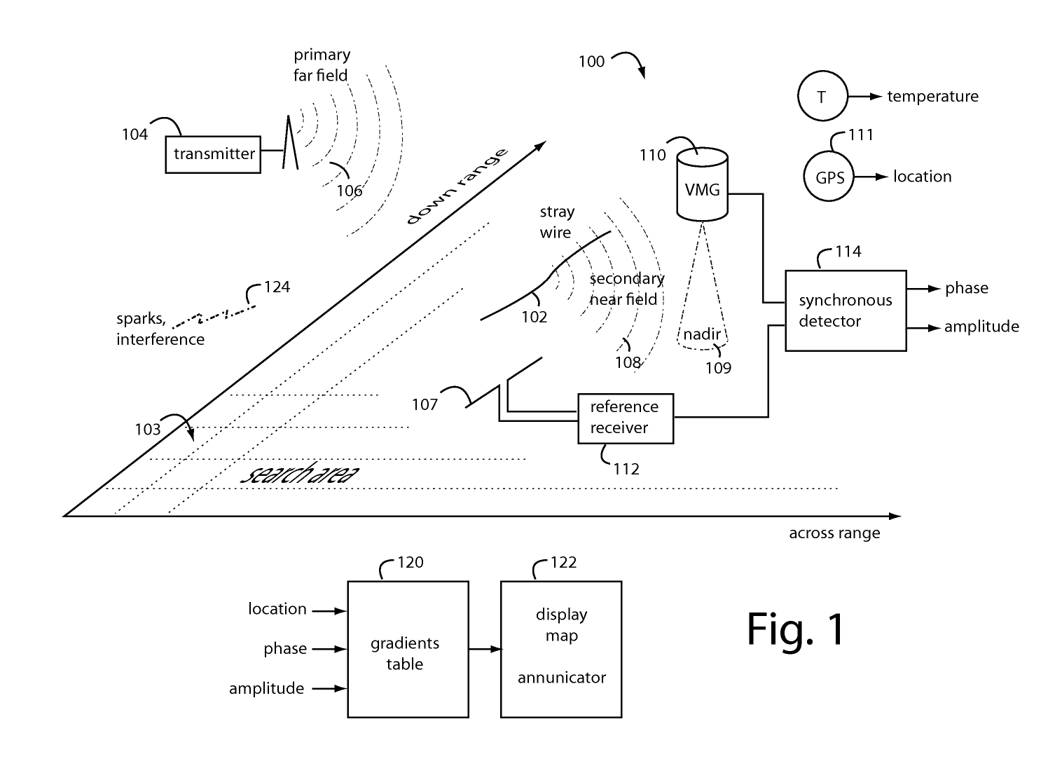

FIG. 1 represents a stray-wire finding device of the present invention, and is referred to herein by the general reference numeral 100. The stray-wire finding device 100 is constructed in one embodiment as an expendable, inexpensive sonde and has as its principal goal the discovery of the existence and placement of any stray wires 102 laying horizontally on the surface in the dirt or under ground cover in a search area 103. The search area can be any kind of landsite.

An unrelated, but not-too-distant radio transmitter 104 is illustrated as emitting a spherically spreading electric far-field primary wave 106 that is serendipitously induced into the stray wire 102. This same far-field primary wave 106 is sampled by a receiving dipole antenna 107 to capture its phase. Any such stray wire 102 receiving enough such serendipitous energy will re-radiate a cylindrically spreading, near-field secondary wave 108 having both magnetic and electric components in its near field.

Maxwell's equation for a radiating wire holds that the power density of far-field transmissions attenuates or rolls off at a rate proportional to the inverse of the range to the second power (1/range²) or −20 dB per decade. Such slow attenuation over distance is why far-field transmissions can be used to communicate over very long ranges. Localized magnetic field energy does not radiate so well into free space, and is restricted to the “near-field.” The power density of near-field electric and magnetic transmissions attenuates at a rate proportional to the inverse of the range to the sixth power (1/range⁶) or −60 dB per decade.

The advantage here in these embodiments is the magnetic near-field phenomenon allows pinpoint measurements to be taken from a nadir spot 109 by simply probing around in a small area 103 from above the ground surface and measuring at many points to paint a highly detailed map or table of the local vertical magnetic gradients.

A vertical magnetic dipole gradiometer (VMG) 110 associated with nadir spot 109 is mounted to be carried by a vehicle, e.g., in a systematic search pattern above the ground in an area 103 assumed to have stray wires 102 lying about. If VMG 110 encounters any secondary waves 108, it will almost certainly cut through their near fields, and that includes a vertical magnetic component. Intelligent movement about the search area while continually sampling can provide useful gradiometric data including phase and amplitude.

It is, of course, typical for the samples to be logged into a relational database according to the navigational positions at which they were collected. A conventional GPS receiver 111 is an economic way to gather the needed positional data, but authorized p-code Military-GPS receivers, Russian GLONASS, and even inertial navigation methods can be used as well. The authorized p-code Military-GPS receivers can provide centimeter position solution accuracies at even high vehicle velocities. The relational data is thereafter useful in rendering local maps on portable screen displays for realtime operator use.

The not-to-distant radio transmitter 104 can be one of opportunity, e.g., a radio or TV broadcast station. Otherwise, it can be mounted on the same vehicle as the VMG 110, or on another vehicle in the same convoy or a flight wing overhead. The most serious forms of interference will be local, man-made equipment sources. For example automobile and truck generators, alternators, and ignition systems. The advantage is these sources are usually friendly, and therefore accessible and available for corrective devices.

A reference receiver 112 tunes and amplifies a sample of the far-field primary wave 106 to produce a phase reference signal. A synchronous detector 114 uses the phase reference signal to make phase measurements of the magnetic signals received by VMG 110.

Gradients are not directly provided by VMG 110 because it only yields measurements of one nadir spot 109 at a time. Gradients become apparent when measurements stored in memory from two or more different nadir spots are compared. For example, a three-dimensional gradients table 120 can be used to store and plot the various phase and amplitude measurements of the magnetic fields at nadir spots 109. A two-dimensional display map and annunciator 122 is useful to show a user where identified objects may be laying. Here, particular patterns of magnetic gradients over the search area are interpretable by a computer as representing two-dimensional ground surface locations of said linear conductors.

Electrical sparks and interference 124 can be caused by nearby electrical equipment like generators, alternators, and engine ignition systems. The strength of such interference 124 can compete with or overwhelm the magnetic wave VMG 110 senses in secondary wave 108. Countermeasures are therefore needed to squelch the adverse effects of such interference.

Some of the noise seen from noisy vehicle ignition module can be screened out. For example, with an algorithm implemented to sync up to an external pulse and cause the next few microseconds of data to be blanked out. In tests, this helped reduce the noise floor up to 15-dB. The blanking time is best left adjustable by the users. The number of receiver I-Q channels can also be selectable by the user. GPS data activity is monitored and flags are set in the data reports to indicate its proper function.

In sonde type applications where the vehicle expense and weight must be kept to a minimum, the data collected is downlinked as early as possible in the processing to a ground controller over a standard datalink. A FIFO is sometimes needed so the report data is streamed down in synchronism with the other datastreams.

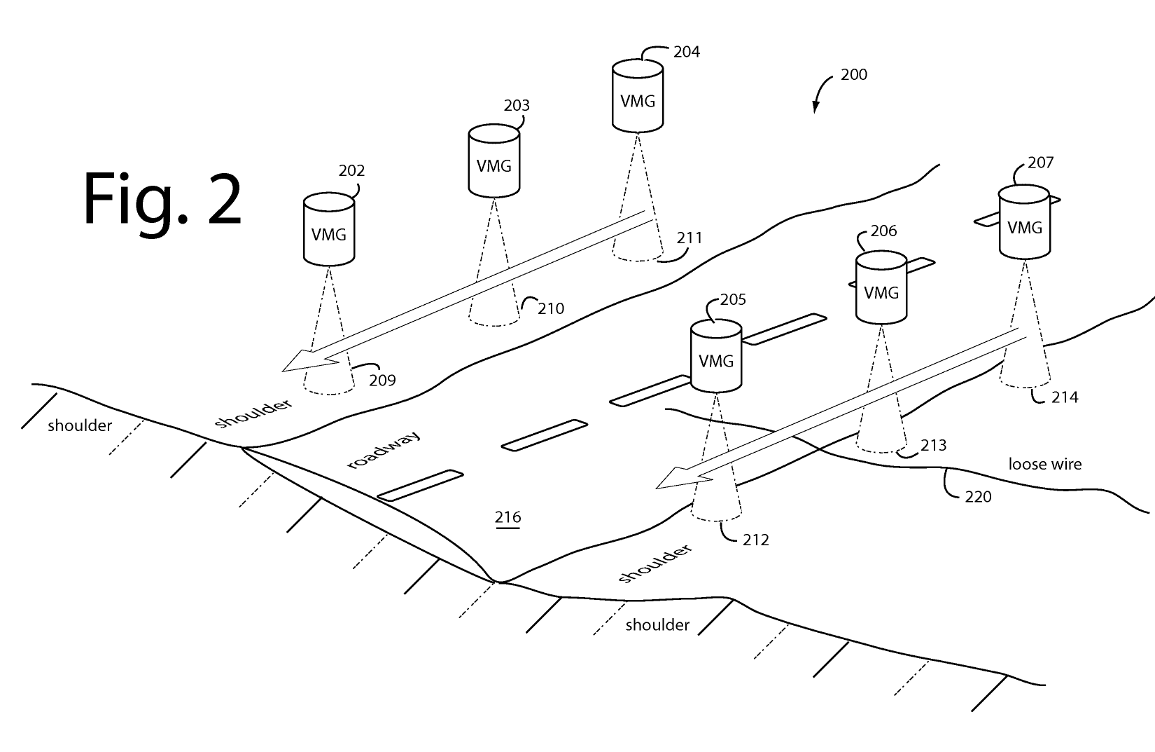

FIG. 2 represents a roadway vehicle application 200 in which six VMG's 202-207 are carried in two single-file arrays, one array on each side of a vehicle. These two VMG arrays are hung out on flip-down outriggers so that their ground nadirs 209-214 will run along the shoulders of a roadway 216. A stray wire 220 is illustrated here as an example, and for purposes of discussion here is shown to come from off one side of roadway 216 and to terminate about in the middle. Such wires can easily be 100-300 feet in length. The end point of such wires will uniquely radiate a spherically spreading pattern, while the rest of the wire will radiate a cylindrically spreading pattern. Precise end-point determinations will look for this transition.

It should be obvious that VMG's 202-204 on the “wrong side” will not pass over stray wire 220 and therefore have little chance of detecting it. However, VMG's 205-207 on the “right” side will pass over, one at a time beginning with VMG 205 and quickly ending with VMG 207. So, if VMG's 202-207 are connected to a suitable signal processor while the vehicle carrying them is in forward motion, detection “blips” will occur in a string in VMG's 205-207, and none at the same time for VMG's 202-204. Wires that end under roadway 216 are of particular interest, and so they must be positively identified if stumbled upon.

Electromagnetic geophysical surveying was originally developed to locate subsurface areas of significantly contrasting electrical conductivity. For example, coal deposits and mine tunnels. A portable radio transmitter on the surface has been used in the past to illuminate the ground, using electromagnetic wave energy from a loop of insulated electrical cable laid on the ground. Secondary electromagnetic waves can be observed if any electrical conductors are present due to the electrical currents induced into them by the transmissions.

It will usually be only the electric field component of the primary electromagnetic wave that can reach far enough to illuminate and induce significant current flow in surface and subsurface conductors. Such current flows cause cylindrically spreading secondary waves to propagate out over the wire length and become observable on and above the surface. These secondary waves will decay with the one-half power of distance from the radiating conductor. Electromagnetic surveys of the observables using magnetic dipole antennas can reveal the orientation, depths, and locations of infrastructures and networks otherwise hidden or not apparent.

The characteristics of the things radiating the secondary waves can be inferred by measuring the magnitudes, orientations, and phases of the secondary waves as they are received at various points on and above the ground surface. The Stolar Research (Rio Rancho, N. Mex.) DeltaEM™ Gradiometer is a portable unit designed to sling from an operator's shoulders using a harness. A battery pack can be worn on a belt around the waist. The Stolar Research DeltaEM gradiometer uses dual independent antennas to measure the amplitude and phase of any secondary electro-magnetic waves appearing.

A difference in measurement between two identical receiving antennas, or two different measures of a moving antenna, can be plotted as a gradient. Measurements from the same antenna taken at different points is how embodiments of the present invention operate.

The primary wave, the electric field that travels directly from the transmitter to the receiver, is preferably rejected by the way the receiving magnetic antennas are constructed. The gradients can be measured without significant interference.

Gradient measurements are able to resolve much finer electronic details than can total field measurement devices. A gradiometer survey of an area will be full of dips and peaks in the secondary wave magnitudes, and phase shifts and reversals, as the receiver passes by radiating conductive targets. A total field measurement for the same area can appear as a homogeneous blur without any details. Small changes in the gradient fields will not look important in total field measurements. Gradient measurement receivers can be configured to naturally reject interfering, unwanted signals.

More recent advancements by Stolar Research in gradiometer technology have shown that single vertical magnetic dipole antennas configured as vector magnometers can provide useful, detailed information about the presence and nature of wires, pipes, and other surface and subsurface conductors.

Large, heavy, power hungry equipment used in the past is not practical in many stray wire detector applications. So embodiments of the present invention attain significant reductions in the size, weight, and power over the same necessities of conventional devices.

There are at least three practical ways to move a gradiometer over the ground surface: (a) handheld, (b) on a ground vehicle, or (c) on a low-flying airframe. The ground vehicle has a better chance of being able to tolerate larger power demands, heavier weights, and larger sizes, but all applications will benefit if these issues are minimized.

But, ground vehicles, especially small ones can jostle and bounce the receiving antennas so much that the gradiometer measurements are degraded by changing noise floors. Airframes can require minimum flying heights that demand too much separation distance, and the secondary waves are as a consequence made too faint to be detectable.

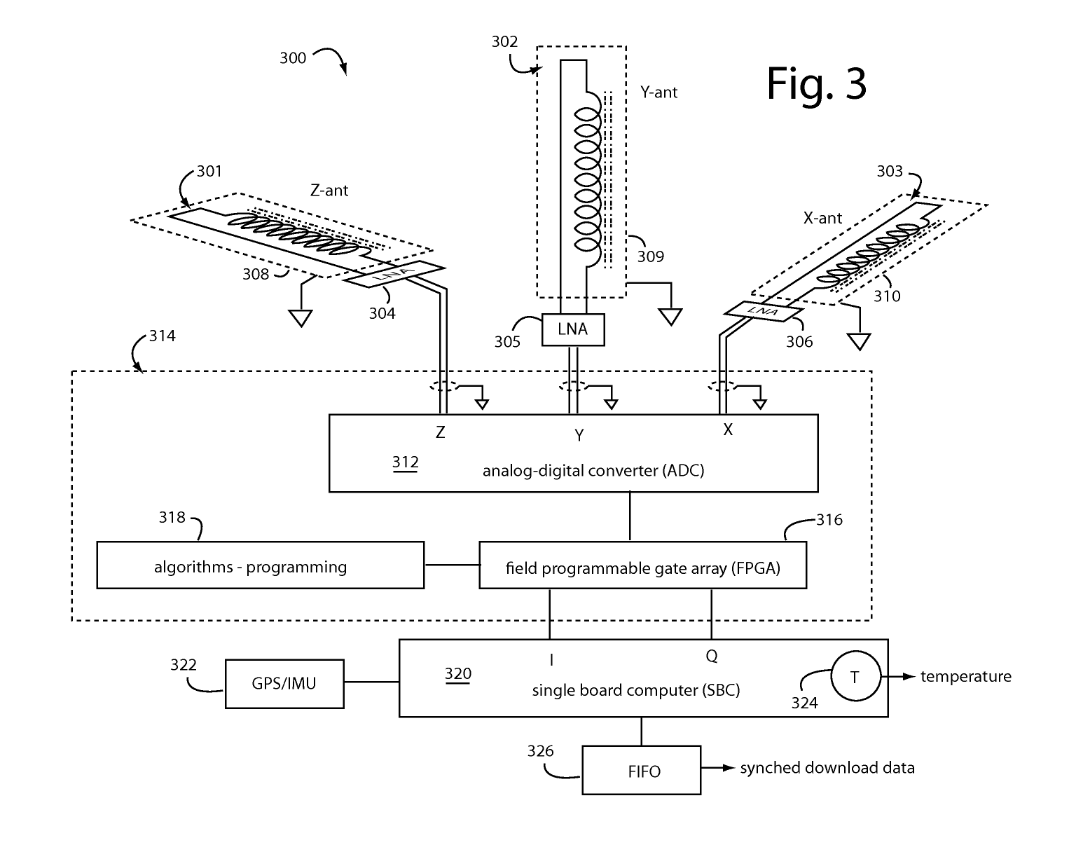

FIG. 3 represents a VMG-type sensor cube and receiver embodiment of the present invention, and is referred to herein by the general reference numeral 300. Three vector magnetometer type magnetic dipole antennas 301-303 are orthogonally arranged into X, Y, and Z orientations relative to a ground surface. Each is equipped with a low noise amplifier (LNA) 304-306. Cylindrical and capped all-copper Faraday shields 308-310 on each antenna 301-303 are used to screen out primary wave electric fields from outside. However, such will still readily pass through the near-field secondary magnetic waves.

The antennas are individually connected in a tri-axial arrangement to an analog-to-digital converter (ADC) 312 in a software-defined radio (SDR) 314. ADC 312 samples and digitizes the analog electromagnetic signals for signal processing by a field programmable logic array (FPLA) 316 according to algorithms and programming provided in a program memory 318. See, Roger H. Hosking, “Putting FPGAs to Work in Software Radio Systems”, (c) 2005-2013, Pentak, Inc. Upper Saddle River, N.J. 07458 http://www.pentek.com.

Additionally available input channels in ADC 312 are useful in monitoring voltage, current, and temperature measurements to report and understand the system health. A single board computer (SBC) 320 takes in the I-Q data and at the same time matches it with navigation data provided by a GPS receiver or inertial management unit (IMU) 322. A temperature sensor 324 is included to measure SBC operating temperatures. A FIFO register 326 is included to sync to other data links downloaded from the vehicle.

SDR 314 provides in-phase (I) and quadrature (Q) measurements of the magnetic signals respectively received by antennas 301-303. The number of I-Q channels provided is user selectable. In remote controlled vehicle applications, the I-Q channel data is synchronized with other systems and command data using first-in, first-out (FIFO) 326 data registers. In some applications as many as 20,000 samples of raw ADC data needed to be buffered, e.g., to observe the noise signatures better, or to help throttle for downlink streaming. Vehicle ignition noise from the platform can be synchronized and blanked out to control the noise floor, e.g., by as much as 15-dB.

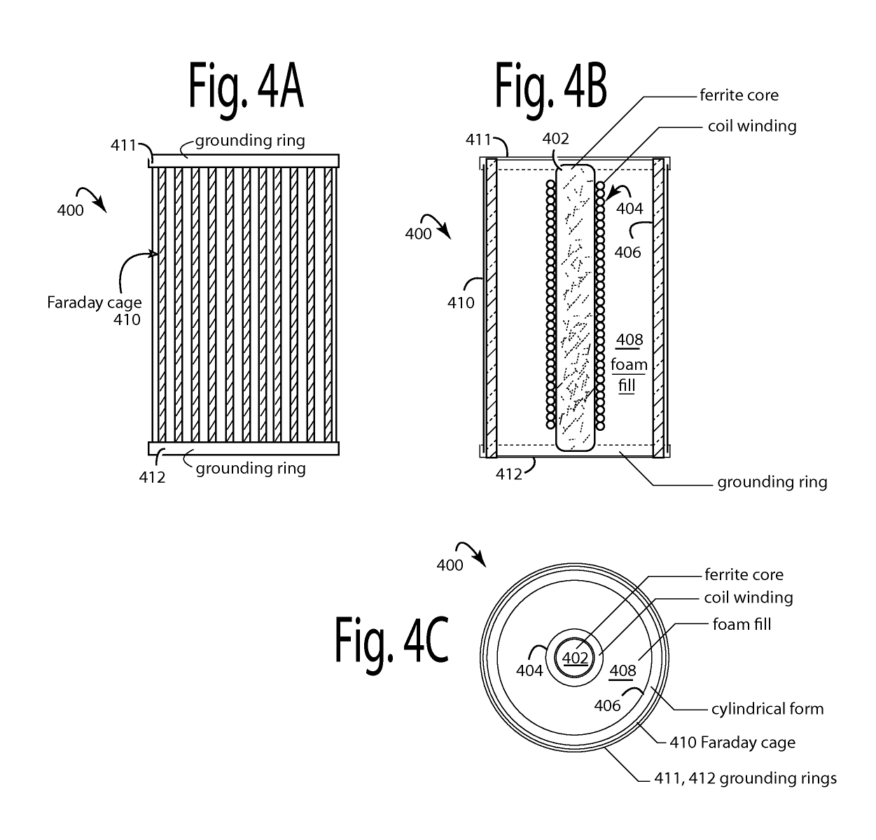

FIGS. 4A-4C represent a vector magnetometer embodiment of the present invention, and is referred to herein by the general reference numeral 400. Vector magnetometer 400 comprises a ferrite rod 402 with a helical-wound coil 404 about 3″ long. The ferrite rod concentrates the magnetic fields received (on axis) with the same orientation. So near-field effects are depended upon.

A hollow phenolic cylinder 406 is coaxially placed around the ferrite rod and is filled with an insulative and stabilizing foam fill 408, e.g., a two-part urethane foam. A pattern of longitudinally arranged copper foil strips 410 on the outside of the phenolic cylinder 406 are connected together at each end by copper grounding rings 411 and 412. The result of this is to create a Faraday shield 414 that allows only magnetic fields to penetrate to the inside to be sensed up by the helical-wound coil 404. The best spacings, widths, and lengths of copper foil strips to use depend on the operating frequencies involved and can be empirically derived. Such copper foil strips can be etched from copper cladding laminated on the outside surface of the hollow phenolic cylinder 406, as is done with common printed circuit boards.

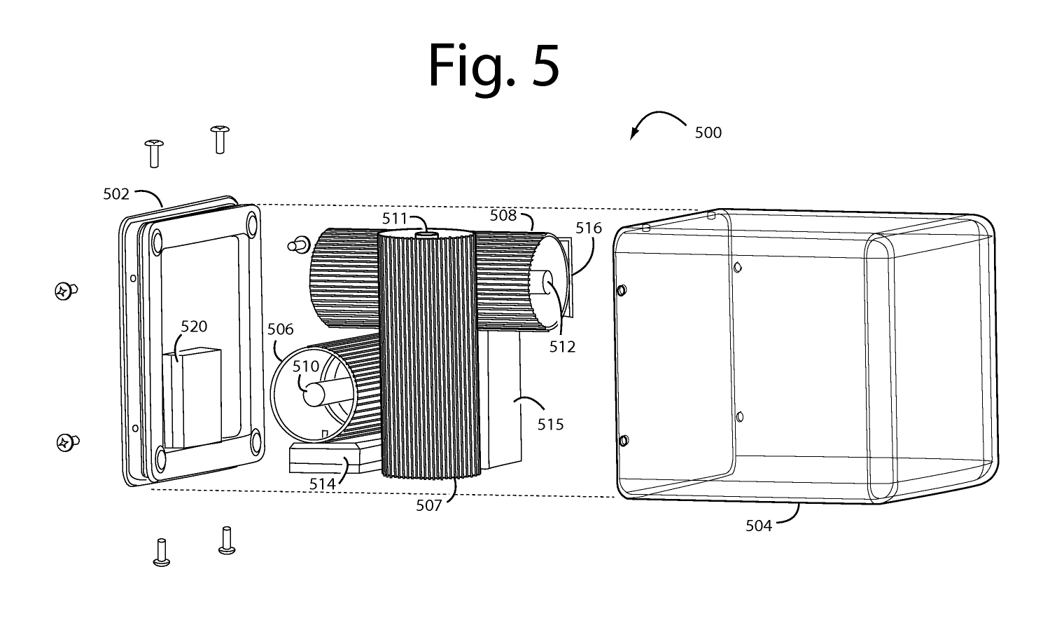

FIG. 5 represents a triaxial sensor cube embodiment of the present invention and is referred to herein by general reference numeral 500. The triaxial sensor cube 500 packs, mounts, and weatherproofs three of the vector magnetometer devices, e.g., antenna 400 as illustrated in FIGS. 4A-4C. A plastic weatherproof top 502 screws onto and seals with a plastic housing 504. Inside, three magnetic dipole antennas 506-508 are arranged orthogonal to one another. Each has a ferrite rod core 510-512, and a low noise amplifier (LNA) 514-516. These are wired to a bulkhead connector 520. The insides of the three magnetic dipole antennas 506-508 are filled with an insulating foam, like urethane, to provide support and resistance to strong vehicle vibrations.

In some applications, only the vertically oriented magnetic dipole antenna 506-508 is used to receive and measure magnetic gradients. The others are used like reference sampling antenna 107 in FIG. 1.

Referring again to FIG. 3, a hardware description language, very-high-speed integrated circuit (VHSIC) Hardware Description Language (VHDL) is used in electronic design automation to describe field-programmable gate arrays, integrated circuits, and other digital and mixed-signal systems. VHDL can also be used as a general purpose parallel programming language. An algorithm was found to be needed in the VHDL programming 318 used by FPGA 316 to monitor data from ADC 312 and to automatically blank noisy data from the signal processing. Such involved an M-of-N criteria to test if the noisy data rose above the rest of the data by a threshold amount, for example 20-dB. The data that met the criteria was blanked out. A delay/storage was therefore included in the original signal processing chain and additional state machines were used to check for the M-of-N criteria.

The various I-Q channels from FPGA 316 can be processed locally or remotely after downloading by a general purpose microcomputer with a gradiometer software application program to detect and annunciate the locations, orientations, and depths of conductors in or on the ground in a survey area. Navigation receivers and maps are combined with the sensor cube 500 to make the results more useful and easy to understand. For example, the instantaneous GPS navigation locations at which each I-Q data sample was obtained are registered and logged with the data downloaded for processing. FalconView, by Georgia Tech Professional Education, is a PC-based mapping application that can be advantageously included to provide meaningful and informative user displays. See, www.falconview.org.

The interpretation of gradiometer data has been described by Larry G. Stolarczyk, t al., in “Detection of Underground Tunnels with a Synchronized Electromagnetic Wave Gradiometer”, AFRL-VS-HA-TR-2005-1066, c. 2005, Proceedings of SPIE Vol. 5778; and also, U.S. Pat. No. 7,336,079, “Aerial electronic detection of surface and underground threats”, issued Feb. 26, 2008.

Software-defined radio (SDR) modules for unmanned aerial vehicle (UAV), radar, and communications applications can be implemented with the 4-channel, 200 MHz ADC XMC module and the Xilinx Virtex®-7 FPGA family. IP can be developed for it using the Xilinx ISE® Design Suite and the Pentek GateFlow FPGA Design Kit.

In general, the Y-antenna 302 is used to receive magnetic signals-of-interest from a small spot on the ground immediately below. The Z-antenna 301 and X-antenna 303 are used to locate and identify nearby transmitters-of-opportunity that may already be radio illuminating metallic subsurface and surface objects.

Referring to FIG. 1, operating from a ground vehicle or airframe usually involves fighting off electrical interference 120 caused by internal combustion ignition systems and generator brushes. The electrical noise coming from an engine contributes to the overall noise floor seen by a receiver. Higher noise floors can rise high enough to inundate any signals of interest.

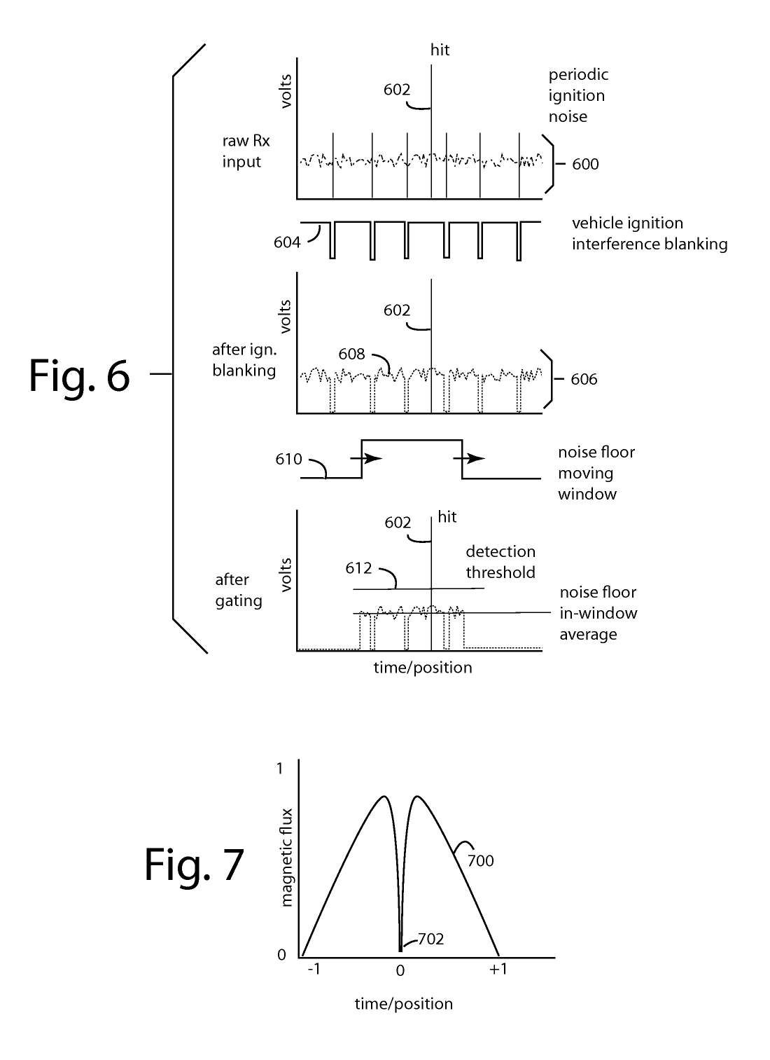

FIG. 6 represents how algorithms 318 (FIG. 3) can be employed to overcome strong interference and produce more reliable detection results. A raw receiver input signal 600 includes regular, periodic spikes caused by an engine ignition system. These can obscure or bury a signal-of-interest 602 that is also a spike, but that is produced as a VMG passes over a wire. Field personnel call this a “hit”. A vehicle ignition interference blanking gate 604 is therefore added. This results in a partially cleaned up signal 606.

A signal noise floor 608 is represented by the ragged tops of signal 606 in FIG. 6. Such noise floor 608 can rise and fall with vehicle motion and terrain changes. These changes make using a fixed squelch level impractical because the best squelch level to use changes minute-by-minute. The best noise floor level to use is therefore computed constantly from only the most recent samples. This is graphically represented by a moving window gate 610 that is 3-5 seconds wide. A detection threshold 612 is raised and lowered according to a most recent noise floor calculation. If any hit 602 exceeds the detection threshold 612, that hit becomes validated as a real target detection. The realtime position of the VMG at the time of the validated hits are logged and used to paint a map and/or sound an operator alarm.

The ill effects of electromagnetic interference (EMI) proved difficult to control in prototypes that were built. Multiple shields were needed in the interconnecting cables as were shielded connectors. The receiver electronics required an eight-layer PCB board design with full power planes and generous decoupling. The receiver and a general purpose single board computer (SBC) were isolated into separate compartments. Differential line drivers and signal lines were needed from the antenna. Low-pass and bandpass filters on the low noise amplifier and receiver boards. Diesel motors have an advantage over gasoline engines in that ignition systems are not needed and the interference they cause are not present and need not be contended with. The Faraday shields 308-310 (FIG. 3) further reduce EMI.

Single point VMG measurements are rather meaningless in isolation unless the stray wire to be detected is moving or the VMG is moving and several measurements with location positions are known. FIG. 7 represents a graph of the magnetic flux sensed by a VMG as its nadir passes over a horizontally disposed wire producing the magnetic flux. The curve 700 represents a continuum of the strengths of the single points measured the position of the VMG relative to the wire.

FIG. 7 illustrates how the magnetic flux in a VMG will respond over time or relative distance to a re-radiating wire. A curve 700 increases in magnetic flux as a VMG moves through time and space closer and closer to a wire and then drops to a low-point 702 when directly overhead.

A radio illumination of a long wire induces standing waves in the wire. As such, zero-crossings will occur at one-half-wavelength intervals along the length of the wire, with maximums at quarter wavelength points. When multiple wires exist with varying characteristic impedance, reflections can obscure the standing wavelengths and will seem to disappear.

There are n−1 modes of EM wave propagation supported on wires and earth conductors. With wire pairs, both the bifilar and monofilar modes will coexist along the wire. Induction initiates monofilar propagation and reflections cause a conversion to a bifilar mode with an attenuation rate of less than 2-dB/km. Since the primary illumination is often orders of magnitude greater than the re-radiated scattered EM wave sourced from the wire, the primary field needs to be suppressed by differential connections of resonant magnetic dipoles in an antenna array. Such arrays comprise both vertical and horizontal magnetic dipoles (VHD and HMD).

Constructive and destructive interference occurs along the EMG traverse at right angles (orthogonal) and at the center of the wire. The length of the wire can be determined from the interference measurements. A fixed antenna or overhead flying source could provide the necessary illumination of the wire.

Referring once again to FIG. 1, if a transmitter 104 is too far away to provide a useful secondary radiation 108 from a stray wire 102, then a local “booster” transmitter will be needed. A good place to fit one would be on a patrol vehicle that operates in the vicinity.

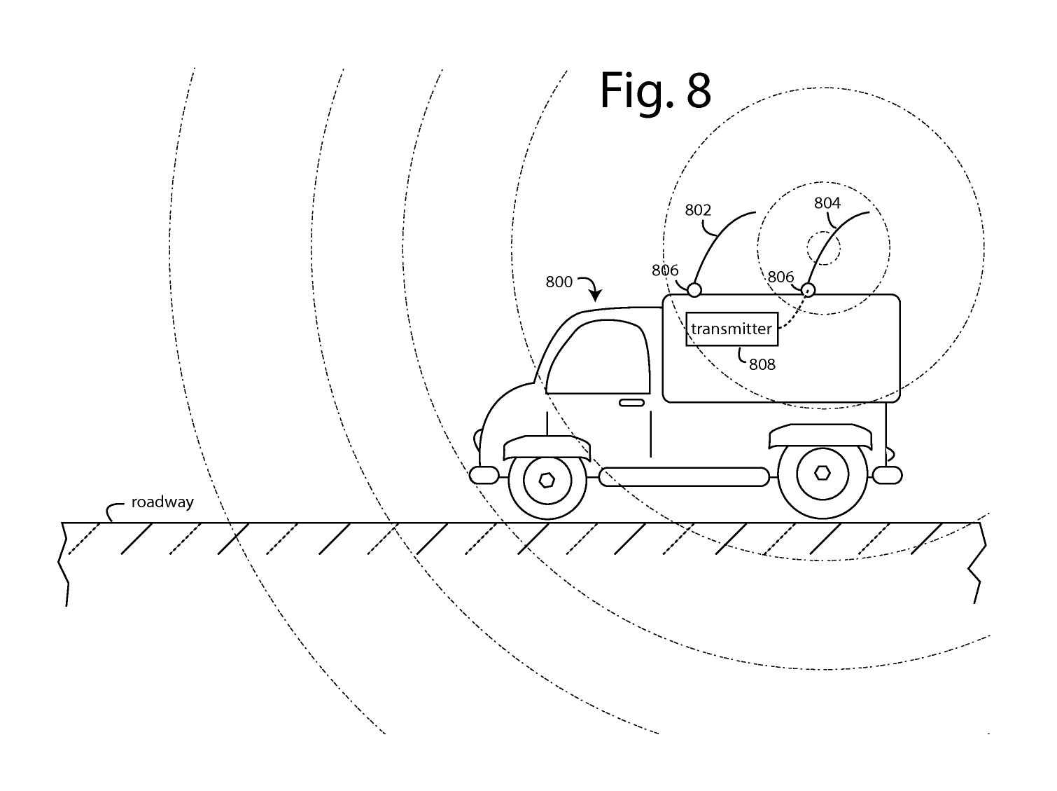

FIG. 8 represents a patrol vehicle 800 fitted with a conventional antenna 802 customarily seen and fitted to cars and trucks of that type. But, a mobile booster transmitter antenna 804 is added to provide a substitute source for primary signal 106 (FIG. 1). The mobile booster transmitter antenna 804 is designed to physically look similar to conventional antenna 802 and other standard antennas, e.g., so as to not to draw special attention to it and the capabilities its presence would imply. It flexibly mounts to vehicle 800 using standard vehicle antenna brackets 806 and connects with coaxial cable to a “booster” transmitter 808.

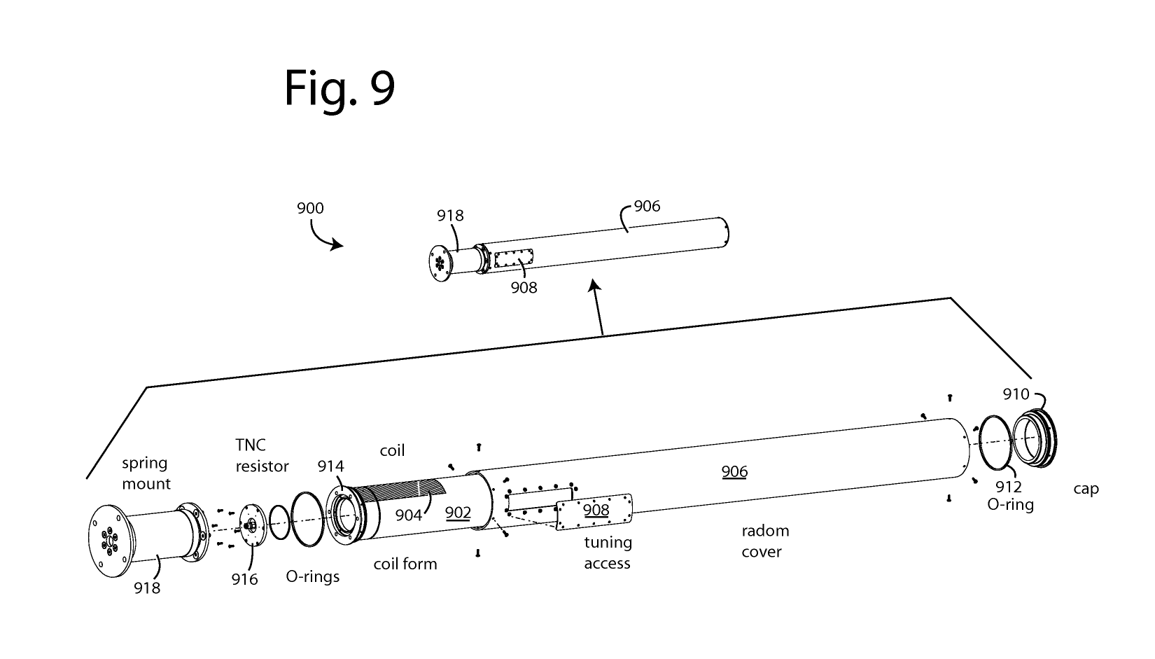

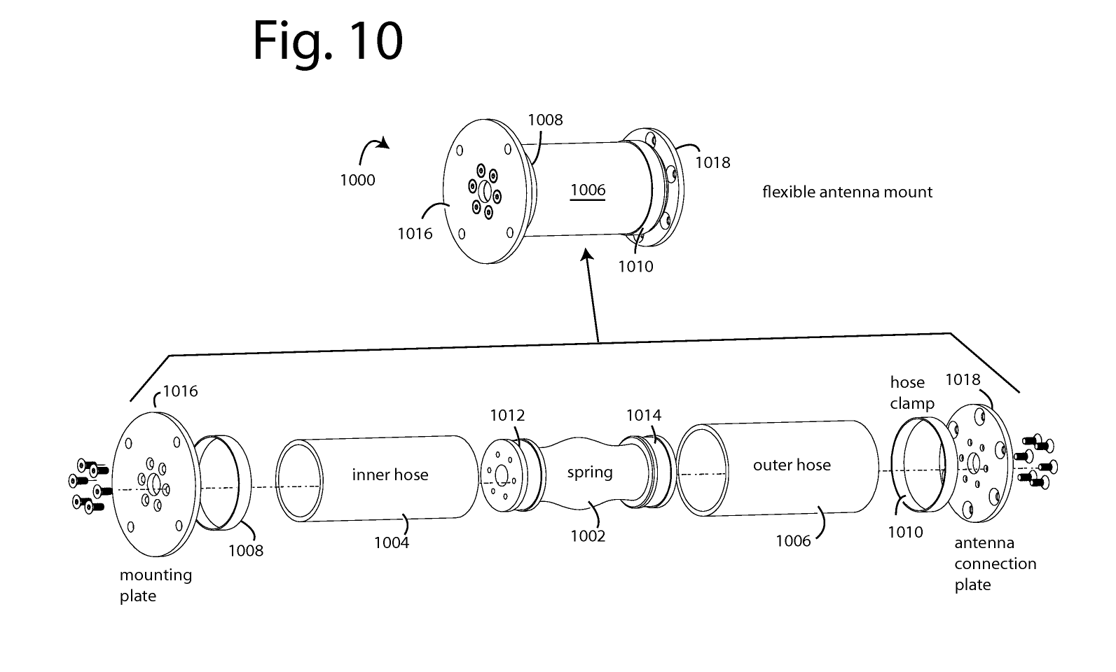

FIG. 9 represents a ruggedized transmitter antenna 900 able to withstand rough service and extreme weather conditions. Although the mobile booster transmitter antenna 804 shown in FIG. 8 was highly simplified, this ruggedized transmitter antenna 900 is preferred. A long, hollow plastic cylinder is used as a coil form 902 to support a coil winding 904 that runs the length. A custom composite form is used for the antenna coil, e.g., as in FIGS. 4A-4C.

If there were no overriding practical considerations, it would be best to use an antenna at least one wavelength long. At a tunable range of 500-kHz to 1500-kHz, that one wavelength translates to 600-meters at the low end and 200-meters at the high end. Clearly not a practical antenna to mount on a vehicle. And so the antenna is wound into coil 904.

A weather-protecting sheath or dielectric radome 906 made of plastic tubing is slipped over coil form 902 and coil 904 and sealed at both ends with O-rings. A gasketed access 908 allows for fine tuning adjustments to coil 904. A hermetic cap 910 fits over the top end of radome 906.

The bottom end of the coil form 902 and dielectric radome 906 are supported by a flange base 914. A TNC resistor assembly 916 fits inside this with an O-ring and provides a coax antenna fitting. A flexible antenna mount 918 fastens vertically between the flange base 914 and a vehicle, e.g., vehicle 800 in FIG. 8. Such flexible antenna mount 918 provides a very stiff, but still forgiving mounting should the antenna 900 encounter any obstacles while riding on top of a vehicle.

A novel small form factor provides for tunable range of 500-kHz to 1500-kHz. The mobile booster transmitter antennas 804 and 900 provide one kilometer of coverage full circle, 360-degrees.

FIG. 10 represents a flexible antenna mount 1000, in an embodiment of the present invention. The flexible antenna mount 1000 includes at its center a steel coil wound spring 1002 which is covered by an inner hose 1004 and an outer hose 1006. For example, 2¾″ ID and 3⅛″ ID coolant hoses. Hose clamps 1008 and 1010 are used to secure the hose ends over spring collars 1012 and 1014. A bottom mounting plate 1016 is secured to collar 1012 with machine screw fasteners, as is an antenna connection plate 1018 to spring collar 1014. The resulting assembly is very stiff and can withstand a lot of torque. It further provides a protected, weatherproof routing for antenna connection cables into the vehicle.

An auto-threshold algorithm coded in firmware and executed by a digital signal processor can be implemented within the synchronous detector 114 (FIG. 1). The noise floor amplitudes have been observed to change with the terrain being traveled over. A continuous, sliding window average is computed over 3-5 seconds and is used as a noise floor baseline. Such sliding noise floor is used to help look for “hits” having signal pops with magnitudes and durations exceeding a threshold amplitude and duration. The best thresholds to use were the ones that had been determined over several months of field testing and trials. The duration thresholds are manipulated to reduce or eliminate random noise spikes caused in the electronics.

An increase in the overall system noise floor can be caused by electrical noise induced by a carrier vehicle. FIG. 6 represents how an engine ignition blanking algorithm that can coded in firmware and executed by a digital signal processor can be implemented within the synchronous detector 114 (FIG. 1). Large noise spikes caused by the vehicle ignition system are exorcised from the receiver signal processing.

The spikes are so short in duration, compared to the signal “hit” data, that quick blanking gates will cause no adverse effects to the system's overall detection performance. The blanking method uses an ignition timing signal from the vehicle to synchronize the blanking sequence. The blanking pulse duration is hard coded and derived from empirical data. When blanking is active only digital zeroes are passed from the analog-to-digital converter (ADC) to the digital signal processing. When the blanking is off, the normal ADC data output is put through.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. A stray-wire sensor, comprising:
a vertical magnetic gradiometer (VMG) configured to sense vertically oriented magnetic fields radiating from any linear conductors laying horizontally underneath near the surface of the ground, and further constructed to be moved by a vehicle above the ground surface over a search area;
a reference antenna and receiver for sampling phase information of the electric far-field of a radio source serendipitously causing said linear conductors to radiate;
a synchronous detector configured to synchronously detect said magnetic fields using said samples of phase information, and to thereby produce a plurality of phase and amplitude measurements of said magnetic fields existent at a plurality of nadir spots;
a log for registering each phase and amplitude measurement of said magnetic field with a corresponding two-dimensional ground surface location of the nadir spot at which it was taken;
a three-dimensional table constructed from data stored in the log and configured to render the existing gradients in said magnetic fields that were measured over an area that includes said corresponding locations;
wherein, particular patterns of magnetic gradients over said search area are interpretable by a computer as representing two-dimensional ground surface locations of identified stray linear conductors.

2. The stray-wire sensor of claim 1, further comprising:
a navigation receiver configured to provide navigation position positions in realtime.

3. The stray-wire sensor of claim 1, further comprising:
a ground vehicle configured to carry the VMG closely over the surface of the ground, and to move on the ground surface over a search area.

4. The stray-wire sensor of claim 1, further comprising:
an airframe configured to carry the VMG closely over the surface of the ground, and to fly above the ground surface over a search area.

5. An electromagnetic survey instrument for locating and identifying ground surface and subsurface linear conductors over a limited survey area, comprising:
a portable platform configured to be moved over a limited survey area and including a navigation receiver able to provide navigation position positions in realtime;
a sensor cube mounted to the portable platform and having a removable lid and generally constructed of a plastic, non-conductive material;
a tri-lateral antenna comprising three ferrite loop antennas each disposed inside its own grounded Faraday shield and orthogonal to one another in an x,y,z configuration, and all fully disposed inside the sensor cube, wherein primary electric wave signals are excluded by said Faraday shields;
a software defined radio (SDR) connected to the tri-lateral antenna and configured to provide I-Q samples of electromagnetic signals detected by any of the three ferrite loop antennas.

6. The electromagnetic survey instrument of claim 5, wherein:
the portable platform comprises at least one of a handheld device, a ground vehicle, and an airframe which are constructed to provide operating power and data communication capabilities.

7. A method of stray wire location sensing, comprising:
moving a magnetic field sensor over the ground surface of a two-dimensional search area;
concentrating any magnetic fields encountered by the magnetic field sensor with a vertically oriented ferrite rod;
sensing any magnetic fields concentrated in the vertically oriented ferrite rod with a concentric coil winding;
measuring and logging the phases and amplitudes of currents induced in the coil winding according to a location they were obtained in the search area;
building a three-dimensional table of the phase and amplitude measurements obtained to render a map of the magnetic gradients; and
interpreting particular features of said rendered magnetic gradients to indicate the positioning of a horizontally lying stray wire on the ground surface responsible for radiating a magnetic field.

8. The method of claim 7, wherein:
the moving is provided by a ground vehicle or airframe.

9. The method of claim 7, wherein:
the concentrating occurs inside a Faraday screen configured to exclude electric fields from said coil winding.

10. The method of claim 7, wherein:
the measuring includes a synchronous detector using a sample obtained from a nearby radio transmitter as a reference frequency for said measurements.

11. The method of claim 7, further comprising as a preliminary step:
Illuminating the search area with radio transmissions from a radio transmitter that serendipitously induce currents in said stray wires and thereby cause a secondary radiation of near field magnetic waves.
